(19) United States
(12) Patent Application Publication
(10) Pub. No.: US 2012/0143536 A1
(43) Pub. Date: Jun. 7, 2012

(54) SYSTEM AND METHOD FOR ANALYZING ENERGY USAGE

(75) Inventors: Gerald George Greaves, Simpsonville, SC (US); Frank O'Brien-Bernini, Granville, OH (US)

(73) Assignee: OWENS CORNING INTELLECTUAL CAPITAL LLC, Toledo, OH (US)

(21) Appl. No.: 13/311,079

(22) Filed: Dec. 5, 2011

Related U.S. Application Data
(60) Provisional application No. 61/419,687, filed on Dec. 3, 2010.
(60) Provisional application No. 61/445,316, filed on Feb. 22, 2011.

(51) Int. Cl. G06F 19/00; G06Q 40/00

(52) U.S. Cl. 702/60; 705/35

(57) ABSTRACT

Systems and methods for analyzing energy usage of a structure include reading data associated with the structure, determining the energy usage of the structure, conducting a thermal analysis of the structure, and generating/displaying the results of the energy analysis. The data associated with the structure includes basic information regarding features and aspects of the structure, devices associated with energy usage, and utility bills. Energy usage from occupant activity can be isolated from energy used for heating and cooling of the structure. Other embodiments include real-time monitoring and calculating of energy usage, energy efficiency, and savings from energy-based improvements.

### CROSS REFERENCE TO RELATED APPLICATIONS

This application claims priority to, and any other benefit of, U.S. Provisional Patent Application Ser. No. 61/419,687, filed on Dec. 3, 2010 and entitled SYSTEM AND METHOD FOR ANALYZING ENERGY USAGE (Attorney Docket No. 27544/04033). This application also claims priority to, and any other benefit of, U.S. Provisional Patent Application Ser. No. 61/445,316, filed on Feb. 22, 2011, and entitled SYSTEM AND METHOD FOR ANALYZING ENERGY USAGE (Attorney Docket No. 27544/04053). All of the foregoing applications are hereby incorporated by reference.

### COPYRIGHT NOTICE

A portion of the disclosure of this patent document contains material which is subject to copyright protection. The copyright owner has no objection to the facsimile reproduction of the patent disclosure, as it appears in the Patent and Trademark Office patent files or records, but otherwise reserves all copyright rights whatsoever.

### BACKGROUND

There are many reasons for homeowners to improve the energy efficiency of their homes. From a very high level it reduces our impact on climate change, improves our energy security, and reduces the load on the electric grid. At the individual homeowner level it reduces energy costs, can improve home value, and provides insurance against future energy cost increases.

However, there are also many reasons homeowners do not improve the energy efficiency of their homes. One barrier to homeowners is the lack of low cost, reliable, and easy to understand information on how their home is performing from an energy use perspective, and what improvements make sense. Homeowners can also hire professionals to conduct an energy audit of their home. However, these inspections are not inexpensive and the results may not agree with actual energy bills or usage.

### SUMMARY

The invention includes a computer implemented method for analyzing energy usage of a structure, including: reading data associated with the structure, wherein the data associated with the structure includes utility usage information; determining an energy usage of the structure by analyzing the data associated with the structure; conducting a thermal analysis of the structure based on the energy usage of the structure; generating an energy analysis of the structure; and displaying the energy analysis of the structure. Systems directed to the same invention are also included.

### BRIEF DESCRIPTION OF THE DRAWINGS

In the accompanying drawings, which are incorporated in and constitute a part of the specification, embodiments of the invention are illustrated, which, together with the summary of the invention given above, and the detailed description given below, serve to exemplify principles of the invention.

FIG. 1 depicts an exemplary system for analyzing energy usage utilizing computer systems connected through a network;

FIG. 2 is a block diagram of an exemplary computer system for analyzing energy usage;

FIG. 3 is a flow diagram of an exemplary method for energy usage analysis;

FIG. 4 is a flow diagram of another exemplary method for energy usage analysis;

FIG. 5 is a table listing exemplary inputs to generate a description of a structure for a thermal analysis;

FIG. 6 is another table listing exemplary inputs to generate a more detailed description of a structure for a thermal analysis;

FIG. 7 is a chart showing an exemplary heating balance point;

FIG. 8 is a chart showing an exemplary cooling degree hours;

FIG. 9 is an exemplary display of an exemplary energy analysis;

FIG. 10 is another exemplary display, including a magnified view of a portion of the display of FIG. 9;

FIG. 11 is a block diagram of an exemplary system for analyzing energy usage in real time;

FIG. 12 is a flow diagram of an exemplary method for comparative energy usage analysis in real time; and

FIG. 13 is an exemplary display of an exemplary daily comparative energy analysis.

### DETAILED DESCRIPTION

Conducting energy analyses of existing homes has all the challenges of energy modeling of new homes plus uncertainties about the details of construction, insulation, window properties, HVAC efficiencies, etc. While the present discussion refers to “homes” and “homeowners,” it is equally applicable to any other type of similar building or structure and to those owners and managers (e.g., in the case of apartments, condominiums, offices, etc.).

Fortunately, existing homes have one significant advantage: their utility bills are known. Careful analysis of the energy usage from 12 months of utility bills, plus an energy analysis of the home based on simple data that most homeowners can obtain for themselves, provides a detailed picture of the energy use of the home. Through the analysis of utility bill data, the efficiency of the home and occupant behavior can be decoupled. The home can then be compared to various other homes, e.g., typical older homes, homes built to various codes, and highly efficient homes. Finally, the cost effectiveness of applicable energy conservation measures can be assessed. These steps can be accomplished without the need to conduct an on-site energy audit of the home, though one may be done nevertheless as a component of one or more embodiments of the invention.

Prior to discussing the various embodiments, a review of the definitions of some exemplary terms used throughout the disclosure is appropriate. Both singular and plural forms of all terms fall within each meaning:

“Logic,” as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic such as an application specific integrated circuit (ASIC), or other programmed logic device. Logic may also be fully embodied as software.

“Software,” as used herein, includes but is not limited to one or more computer readable and/or executable instructions that cause a computer or other electronic device to perform functions, actions, and/or behave in a desire manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Browser” as used herein includes, but is not limited to, any computer program used for accessing sites, data or information on a network (as the World Wide Web) including, for example, toolbars and application programs. The browser may be configured to access, download, and/or execute logic and/or software located remote computers. Examples of browsers include Internet Explorer by Microsoft Corp. of Redmond, Wash. and Safari by Apple Corp. of Cupertino, Calif. Other browser programs are also applicable.

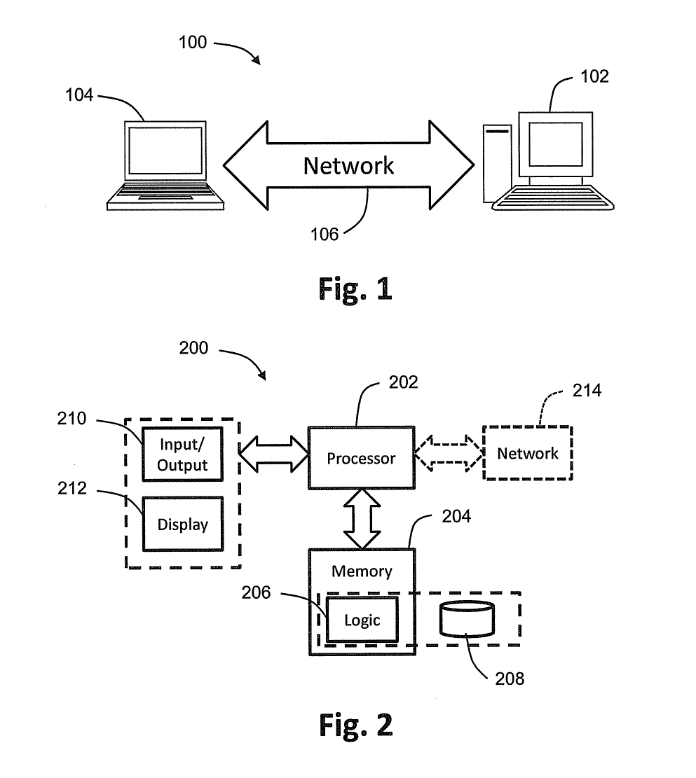

In one embodiment, a computer system 100 having logic for analyzing the energy usage of a building or structure is provided and shown in FIG. 1. System 100 includes, for example, a server computer system 102 and one or more client computer systems 104. The server 102 and client computer systems 104 can be connected together through a data or communication network 106.

FIG. 2 illustrates another embodiment of system 100 in the form of a computer system 200. The computer system 200 can include a processor 202, computer-readable media such as memory 204, one or more input/output devices 210, such as, for example, a keyboard, mouse, printer, monitor/display 212, etc. Memory 204 can include various embodiments of logic 206 for analyzing energy usage. Logic 206 may also include, for example, one or more databases 208 associated with memory 204. Alternatively, the databases 208 may be accessed from a remote location or server over network 214.

The computer system 200 may also include network connectivity 214 to the World Wide Web or Internet to access one or more websites and/or may also be connected to an intranet and/or extranet for further access to data and programs. The computer system 200 may be a stand-alone system such as personal computer (i.e., desktop, laptop, netbook, tablet, smart phone, etc.) or may be a networked system having one or more servers 102 providing data, programs and/or data processing for one or more client computers 104, as shown in FIG. 1. The network 214 may be wide area, local, wired and/or wireless. The logic 206 for analyzing may be embodied in a server 102, client 104, browser, computer-readable medium or other program such as, for example, a spreadsheet program (e.g., Excel by Microsoft Corp. of Redmond, Wash.).

Independent of the exact computer system embodiment, the system and method comprises logic 206 for analyzing energy usage of a building or other structure, such as, for example, a home. The logic 206 includes reading data and/or parameters associated with the home or other building structure. The reading of data can include reading user entered data and/or data from one or more other sources such as, for example, memory, remote servers, or other data sources. The logic 206 further includes analyses for decoupling occupant behavior from the energy efficiency of the home or structure. In one embodiment, the energy efficiency can be compared to the energy efficiency of one or more reference structures which may or may not be similar to the home or building structure analyzed. Alternatively, the reference structure may be the same structure such as, for example, prior to some change or improvement in the structure (e.g., 12 months after additional insulation has been added to the structure). In other embodiments, the energy efficiency may be used to generate an energy efficiency indicator, such as, for example, a heating index and generation of potential energy efficiency improvements (including, for example, costs, savings, and payback) to the home or building structure being analyzed.

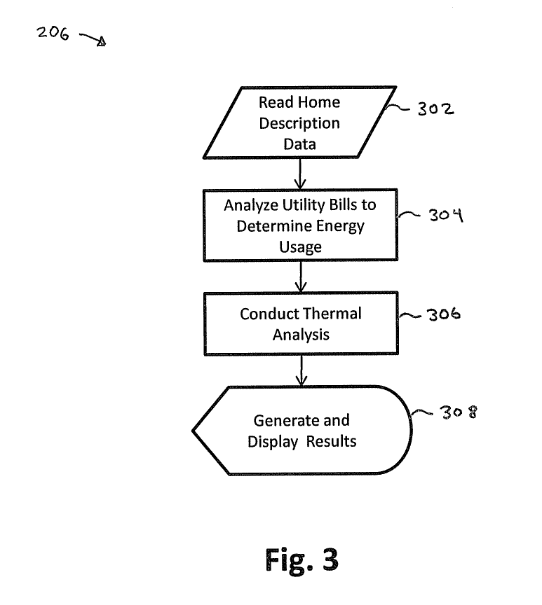

Referring now to FIG. 3, a flow diagram illustrating one embodiment of logic 206 for energy analysis is shown. The rectangular elements denote processing blocks and represent computer software instructions or groups of instructions. The quadrilateral elements denote data input/output processing blocks and represent computer software instructions or groups of instructions directed to the input or reading of data or the output of data. The flow diagrams shown and described herein do not depict syntax of any particular programming language. Rather, the flow diagrams illustrate the functional information one skilled in the art may use to fabricate circuits or to generate computer software to perform the processing of the system. It should be noted that many routine program elements, such as initialization of loops and variables and the use of temporary variables are not shown. Furthermore, the exact order of the process steps need not necessarily be performed in the order shown or described herein and may be modified.

The flow starts in block 302 where home description data is read, which can include various information about the home including the home's utility bill data. Block 304 analyzes the utility bill data to determine the home's energy usage. The home's energy usage is then used conduct a thermal analysis of the home in block 306. In block 308, the home's energy usage is generated and displayed.

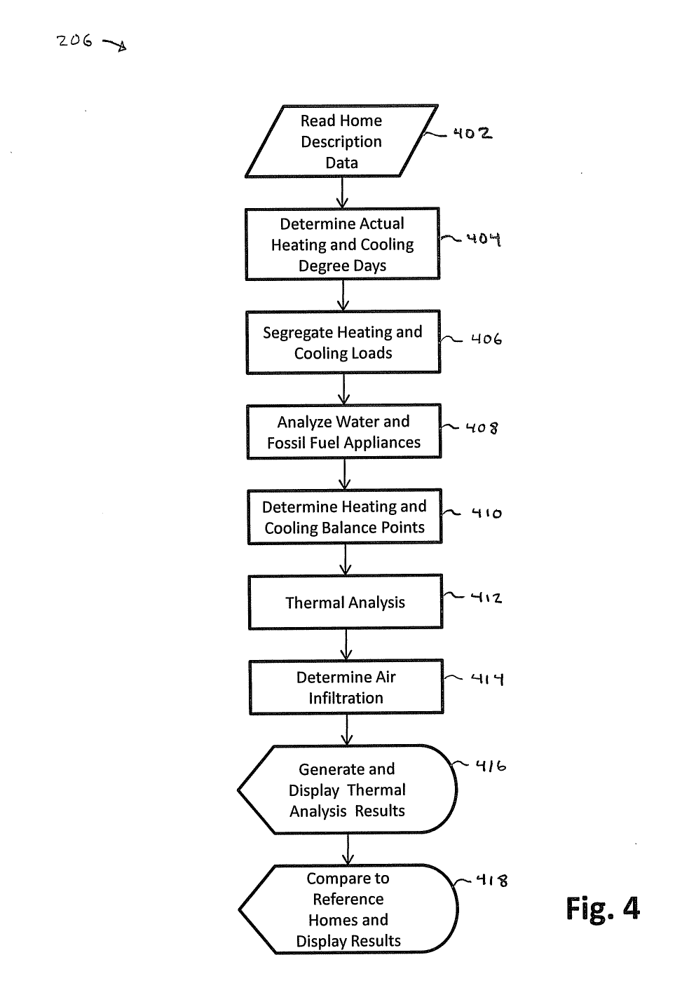

FIG. 4 illustrates a flow diagram showing another embodiment of logic 206 for energy analysis. The flow starts in block 402 where home description data is read, which can include various information about the home including the home's utility bill data. This data can include data providing a basic description of the home to be analyzed, including, zip code, floor area per story, the age of the home and any relevant improvements, fuels used for heating, hot water, cooking, and cloths drying, 12 months of energy usage from utility bills, the actual heating degree days (base 65 F) and cooling degree days (base 65 F) for the corresponding time period, and the summer and winter thermostat setting. Most home or building owners have or can readily obtain this information. As shown in block 404, heating degree days and cooling degree days can be determined using a reference source. For example, heating degree days and cooling degree days for a particular location are available online at http://www.degreedays.net/.

In blocks 406-410, the logic analyzes the home data and energy usage from the utility bill data to determine how it is divided amongst a plurality of usage categories, for example, heating, cooling, electric base load, and fossil fuel base load for the home. The base load for the home may include, for example, energy used by home appliances for water heating, cooking, clothes drying, etc., and other occupant activity. In other embodiments, less than all of these usage categories or parameters can be used. Energy usage can also be shown in terms of cost or equivalent CO₂ emissions based on state average energy costs from the US Energy Information Administration and state average CO₂ emissions for electricity from the US Environmental Protection Agency. Fossil fuels have the same CO₂ emissions independent of location.

In block 410, heating and cooling balance points are determined from the energy usage. In addition heating degree days and cooling degree days data may also be adjusted. The age of the home or other structure and relevant improvements, and the climate zone are used to define properties of the home or structure to conduct a thermal analysis in block 412. These properties are based on typical construction practices for the climate zone and age of the home or structure. In one embodiment, the thermal analysis is based on the American Society of Heating, Refrigerating and Air-Conditioning Engineers (ASHRAE) standard 90.2, which is hereby fully incorporated by reference and a portion of which is attached in the appendix of the provisional application drawings, incorporated by reference. Other thermal analysis standards may also be used in addition to or as an alternative.

In block 414, the logic estimates the air tightness of the home or other structure based on the thermal analysis and the actual heating and cooling energy used. In blocks 416 and 418, thermal analyses are generated for the home and conducted on comparable homes, such as for example, similar homes in the same climate built to different levels of energy efficiency; a typical 1970's home, a 2006 IECC (International Energy Conservation Code) home, and 2009 IECC home and a high performance, solar ready home. Other types of homes or structures can also be included such as, for example, the same home prior to being improved or changed. The energy usage of the home or structure under evaluation is then compared to the energy usage of some or all of these reference homes or structures. The logic 206 can also calculate an indicator of each home's energy efficiency, such as each home's heating index for additional comparison. The heating index can be defined in one embodiment by the following equation:

$$Home Heating Index = ( \frac{\begin{matrix}Energy Used to Heat \\ the Home [ BTU ]\end{matrix} }{\begin{matrix}Heated Home Area [ {ft}^{2} ] \times \\ \begin{matrix}Heating Degree Days \\ [ Deg F - Days ]\end{matrix} \end{matrix}} )$$

In blocks 416 and 418, the logic further can evaluate several potential energy efficiency improvements and provides estimates of the cost to implement, the savings in utility bills, and the payback time. Various potential energy efficiency improvements can be selected to be included in an energy analysis of the hypothetically improved home. The energy usage and/or energy efficiency (e.g., heating index) of the hypothetically improved home can also be compared to the unimproved (current) home and one or more various reference homes or structures. All of this information may be displayed for a user (i.e., home or building owner or manager) on a monitor or other display, such as a printed report. The user can use this information to guide the implementation of energy efficiency improvements

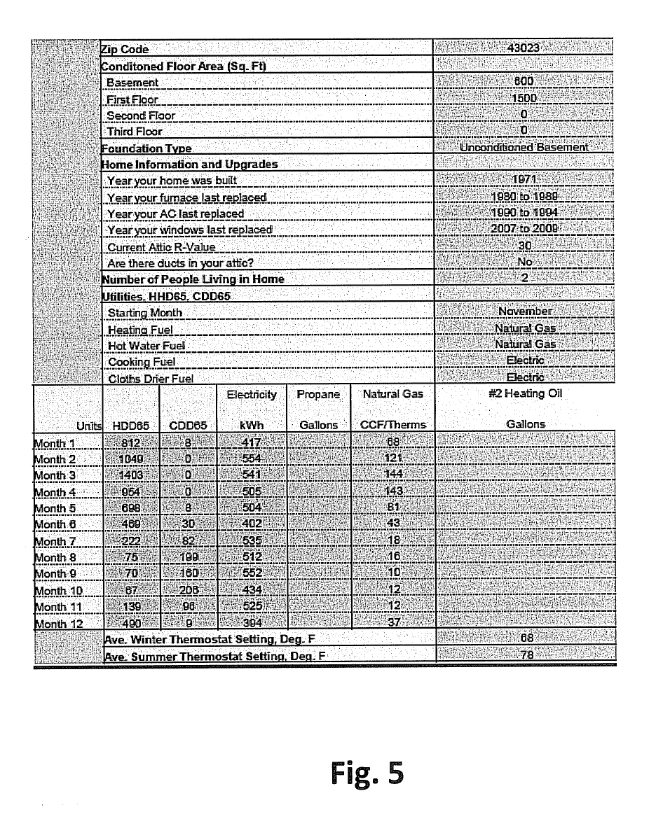

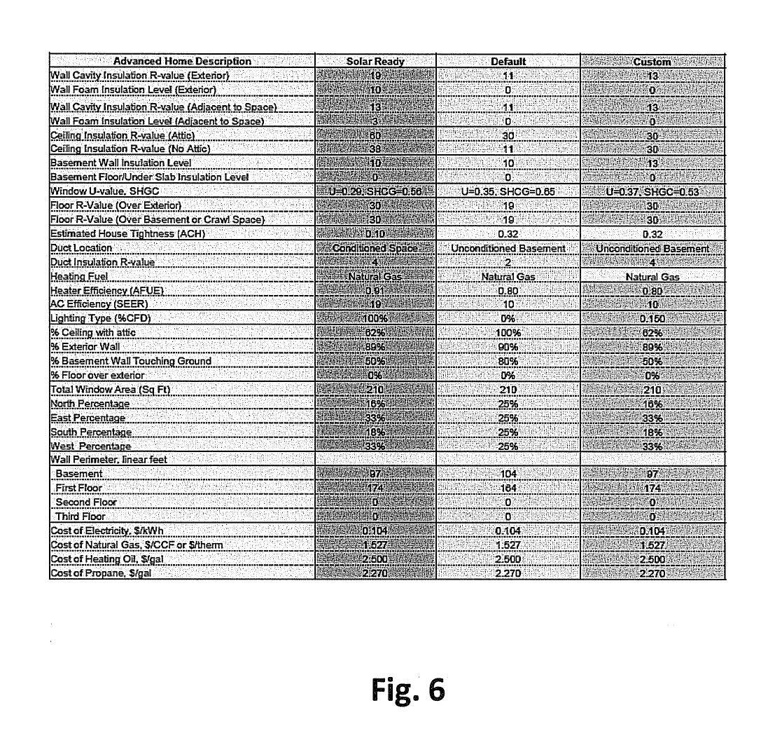

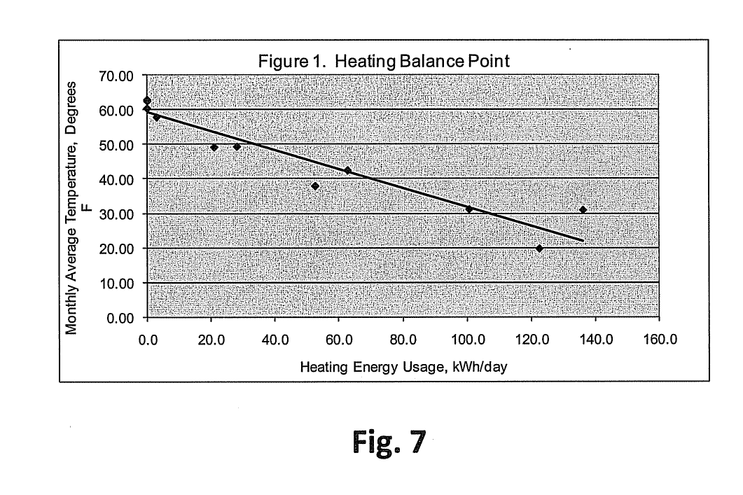

In one embodiment, home description data inputs can be divided into two groups. The first group is shown by way of example in FIG. 5 and is used by the logic 206 for the energy analysis to be completed. The logic 206 uses these inputs to generate a description of the home for a thermal analysis. The second set of data inputs are more detailed options and are shown by way of example in FIG. 6. These inputs allow the logic 206 to generate a more detailed description of the home's energy analysis. The first group of data inputs are described below:

Zip Code.

Conditioned floor area in square feet for the basement, first floor, second floor, and third floor. Any of them can be zero.

Foundation type. Either conditioned basement, unconditioned basement, crawl space or slab.

The year the home was built.

The year the furnace was installed or replaced, before 1950, 1951 to 1979, 1980 to 1989, 1990 to 1994, 1995 to 2006, 2007 to 2009, after 2009.

The year the air conditioner was replaced, before 1950, 1951 to 1979, 1980 to 1989, 1990 to 1994, 1995 to 2006, 2007 to 2009, after 2009, none if there is no AC.

The year the windows were replaced, before 1950, 1951 to 1979, 1980 to 1989, 1990 to 1994, 1995 to 2006, 2007 to 2009, after 2009.

The R-value of the attic floor insulation. This can be estimated by multiplying the thickness in inches times 2.6 if the insulation is loose or 3.1 if the insulation is in batts.

Whether there are HVAC ducts in the attic.

The number of people living in the home (occupants).

The first month of energy use and HDD65 and CDD65 data.

12 consecutive months of electricity usage, any fossil fuel usage, HDD65 (i.e., heating degree days, base 65 F) and CDD65 (i.e., cooling degree days, base 65 F).

The average summer and winter thermostat setting.

In one embodiment, the logic 206 reads and analyzes the energy usage from 12 months of utility bills to segregate the energy usage into five buckets; base electric, cooling, fossil fuel appliances, fan (for heating) and heating (e.g., blocks 402-408). In other embodiments, more or less than the five described bucket types may be used. The logic 206 also uses the utility bill data to calculate total usage in terms of energy, dollars, and associated CO₂ emissions.

Analysis of the home data and utility bills allows the logic 206 to determine the heating and cooling balance points for the home (e.g., block 410). In the current embodiment, this is done in several steps. First, logic 206 converts the monthly data to 2 month moving averages. This minimizes the effect of bills being estimated every other month. Then the minimum month is chosen. This minimum electricity usage is adjusted for the number of days in each month, and summed to determine the annual base electric load.

Next, a process is conducted on the fossil fuel usages (e.g., blocks 406-408). For example, if fossil fuel is used for hot water heating, an adjustment is made based on climate. An adjustment may also be made depending on whether cooking and/or clothes drying are also based on fossil fuel. The lowest water heating is in the summer because the incoming water is warmer and often the air around the water heater is also warmer. An adjustment is reduced if the home also uses fossil fuel for cooking and/or clothes drying. The result is the energy used by fossil fuel appliances (e.g., hot water heating, cooking, and/or clothes drying).

The logic 206 also determines the heating load (e.g., blocks 406-408). For fossil fuel heating, the heating energy usage is what's left over after removing the appliances. For heat pumps, the electric base load is subtracted from the total electricity usage and then the heating usage is the sum of all the heating months. Heating months may be assumed to have an average temperature below 60 F. The average temperature is determined from the monthly HDD65 by dividing by the number of days in the month and subtracting from 65 F. So, if a month has 180 HDD65 and 30 days, the result is 6 F which is subtracted from 65 F to get 59 F. The fan energy may be assumed to be 3% of the heating energy usage. Cooling energy is what's left from the electric usage. This information can be shown in kWh, dollars or pounds of CO2 emissions.

The logic 206 determines the heating balance point by, for example, plotting or analyzing the monthly heating energy usage versus the monthly average temperature and using a linear fit to find the temperature where heating is no longer required (e.g., block 410). This is the heating balance point of the home. An example of this is shown in FIG. 7 where the heating balance point is approximately 60 F (at 0.0 kWh/day).

Based on the zip code, a nearby city is chosen by comparing the entered zip code to the zip codes of 162 US cities in a data set build, which may be built into the logic 206 or into the logic accessed remotely. For example, the logic 206 may select the city with the closest zip code on the assumption that proximity in zip code translates to proximity in geography. Other location data may be used such as, for example, GPS, telephone, and/or address. Identifying a nearby city allows several tasks to be performed.

For example, the heating degree days and cooling degree days data can be adjusted to the appropriate base, i.e., the balance point, based on the identification of a nearby city or weather station. A database of, for example, 162 cities can also be employed having the typical heating degree days and typical cooling degree days for each city. The degrees days are determined by multiplying the actual heating degree days (base 65 F) times the ratio of the typical heating degree days with a base of the balance point to the typical heating degree days base 65 F. The typical heating degree days with a base of the balance point are determined by interpolation, as described above in connection with FIG. 7.

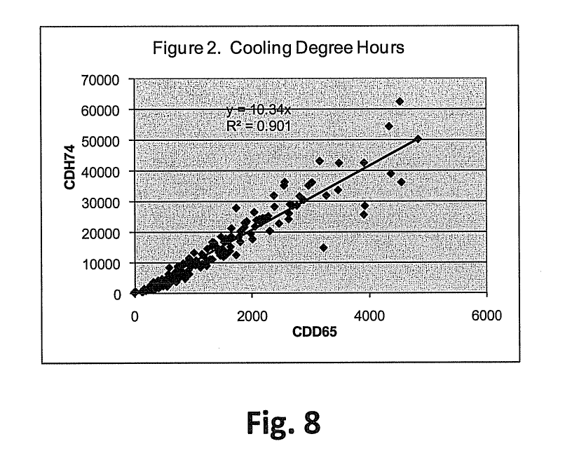

The logic 206 determines the cooling balance in a similar manner (e.g., block 410). Generally, cooling degree hours having base 74 F are preferred to cooling degree days base 65 F, particularly in areas with large day to night temperature swings. However, actual cooling degree hours are not readily available in most cases. To avoid this, cooling degree hours base 74 F may be calculated by the logic based on cooling degree days base 65 F by multiplying by a factor of 10.34. This was determined by comparing typical cooling degree hours base 74 F to cooling degree days base 65 F for 162 cities in the database. The R² value (coefficient of determination) is 0.9 as shown in FIG. 8. Based on this reasonable agreement, this correlation may be used by the logic.

By identifying the nearby city, the logic 206 can determine relevant energy prices, construction cost location factors, climate zone, typical summer and winter mean temperatures, and the CO₂ emission factor from a built-in database or remote data source. When used with the age of the home, identification of the nearby city also may allow the logic to determine a default construction type of the home. The logic 206 can include a database of typical home constructions by climate and age or access this data from a remote source. The type of construction may define the thermal properties of the opaque building envelope. Window and HVAC efficiencies may also be determined by the logic based on the determined climate and when they were last replaced.

The logic's thermal analysis in, for example, block 412, may use the approach outlined in ASHRAE 90.2, which is hereby incorporated by reference. Data or parameters associated with the following are considered:

Exterior Walls.

Exterior Walls, adjacent to Unconditioned (UC) Space.

Basement Walls.

Windows, North.

Windows, South.

Windows, East.

Windows, West.

Ceiling with Attic.

Ceiling (e.g., Cathedral or Flat Roof).

1st Floor over UC Space.

1st Floor over Exterior.

Slab Edge (2′).

Infiltration.

In one embodiment, all of these parameters use load factors from ASHRAE 90.2 except infiltration. In other embodiments, load factors different from ASHRAE 90.2 can be used. The default percentage (i.e., load factor) for exterior walls adjacent to unconditioned spaces is 10%, the default percentage for cathedral ceiling is 0%, and the default percentage of floor over unconditioned space is 0%. The default window area is 10% of the floor area and is uniformly distributed in the four directions. In other embodiments, the user can enter actual values for any of these if the information is known.

In the current embodiment, infiltration may be treated as a special case by the logic 206 (e.g., block 414). First, an initial infiltration in terms of average natural air changes per hour may be made by the logic. This is done by the logic 206 using the climate, the size, the number of stories, the age of the home, and the foundation type parameters in the model by Sherman and McWilliams (Sherman, M. H. and McWilliams, J. A., “Air Leakage of U.S. Homes: Model Predication”, Proc. 10th Conf, Thermal Perf, Ext Env of Buildings, LBNL-62078, (2007)), which is hereby fully incorporated by reference.

The logic 206 then multiplies the initial infiltration by the volume of the home in ft³ and 0.0189 to get BTU/(hour*degree F.). The 0.0189 value is a combination of unit conversions and the density and specific heat of air. This product is then multiplied by 24 hours/day and the heating degree days with a base of the balance point. This gives the first estimate of the energy lost due to infiltration.

The logic 206 may calculate the remaining energy heat flows using the ASHRAE 90.2 procedure (e.g., blocks 412 and/or 416). Then the heating efficiency and duct distribution factors may be applied. This provides the amount of purchased energy for heating. This can be compared to the heating energy from the utility bill analysis. Since the purchased energy for heating should match the actual heating energy purchased from the utility bill analysis, the logic can adjust the initial infiltration within the bounds of 2 times the initial value down to ¼ the initial value. The high end is an estimate of an individual home's variability from the model. The low end is a combination of an estimate of an individual home's variability from the model and some sealing efforts that may have reduced the infiltration. In other embodiments, the higher and lower bounds may be changed. If the heating energy use still does not match utility bill, the logic can apply a multiplication factor to all of the other heat flows to force a match, which may be done independent of the bounds.

The logic 206 can determine the cooling energy based on the adjusted infiltration from above. To get the cooling energy to match the utility bill, the logic can apply a multiplication factor to all the other heat flows to force a match based on cooling energy.

Once this analysis is done, homes with different energy efficiencies can be analyzed for comparison by the logic (e.g., block 418). The comparison can be to several reference homes including, for example, a typical 1970's home, a 2006 IECC home, and 2009 IECC home and a high performance, solar ready home. Using default data for each of these types of homes, a preliminary analysis of these homes can be conducted by the logic to estimate the heating and cooling energies thereof. These are then used to estimate the balance point for each reference home. The heating degree days and cooling degree days are then adjusted for the new balance points as described above. Finally, another analysis is conducted to estimate the total energy used by each of these homes.

In a similar manner, potential improvements to the home are analyzed by the logic. There are, for example, 14 improvement options that a homeowner may consider. These are:

1. Enter raised average summer thermostat, Degrees F.

2. Enter lowered average winter thermostat, Degrees F.

3. Seal top floor ceiling.

4. Enter increased ceiling insulation, OC R-60 recommended.

5. Enter new windows, U=0.29, SHCG=0.56 recommended.

6. Enter increased floor insulation, R-30 recommended.

7. Seal your band joist.

8. Enter a new furnace AFUE, 0.91 recommended.

9. Enter a new AC SEER, 19 recommended.

10. Caulk around windows, foam sheet in outlets, etc.

11. Seal and insulate accessible ducts.

12. Insulate the hot water tank and pipes.

13. Percent switch to compact fluorescent lighting.

14. Add Foamular to exterior walls.

Other improvements may also be added and the above list is not intended to be exclusive. Furthermore, less than all 14 improvements may be analyzed. In the current embodiment, there are 11 separate analyses which can be performed to estimate the energy usage reduction, but not all are necessary. One or more improvements can be combined. For instance, summer and winter thermostat adjustments are handled in one analysis, as are heating and cooling efficiencies. Insulating the hot water heater and pipes, and switching to compact fluorescent lighting do not require additional analysis. Finally, there is one more analysis that combines all of the improvements to get an estimate of the overall energy usage after the improvements.

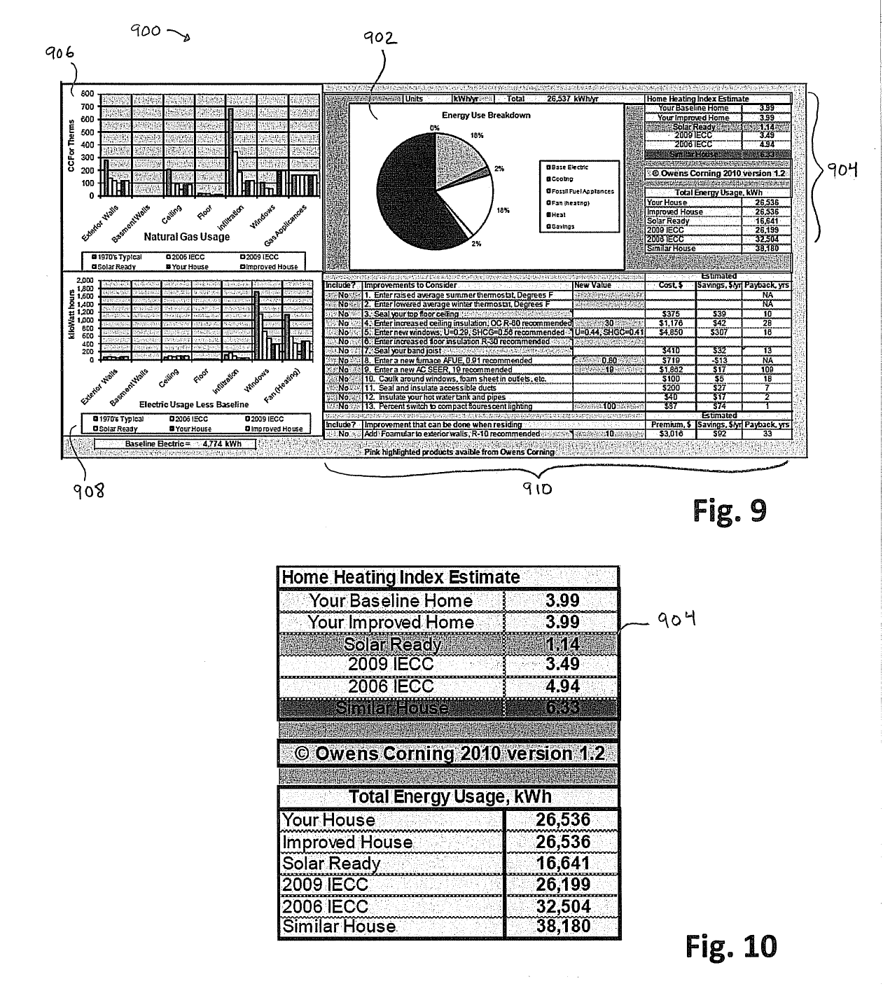

FIG. 9 illustrates one embodiment of a display 900 that can be generated by logic 206. Display 900 includes portions 902-910 summarizing and conveying the energy analysis. Portion 902 graphically summarizes the home's energy breakdown based on buckets or categories. Portion 904 summarizes the homes heating index (including a comparison to one or more reference homes) and total energy usage. Portion 906 summarizes the sources of natural gas usage and includes a comparison to one or more reference homes. Portion 908 similarly summarizes the sources of electrical usage and includes a comparison to one or more reference homes. Portion 910 displays the improvements that may have been done or can be done for comparative analysis on the home. Portion 910 includes a user interface which allows the user to change or modify the data values shown therein. Portion 910 also includes a display of the estimated cost, savings, and payback in years associated with each improvement. FIG. 10 is a magnified view of portion 904.

According to another embodiment, logic 206 can compare a home's actual energy analysis based on different time periods of the home when for example, improvements or other changes in the home's description data have been made. In this embodiment, logic 206 can store the results of a home's first or initial energy analysis (e.g., FIG. 4) which can be associated with an unimproved state. If, for example, improvements or efficiency upgrades have been made to the home following the prior energy analysis, a second or subsequent energy analysis can be performed on the home to determine the actual savings associated with the home's improved state. This second or subsequent analysis can be performed using 12 months (or some other time period) of utility bill data and corresponding actual weather data following the date of the improvement (and any other modified data representing the improvement to the home's description). Hence, the energy analyses of the home in its unimproved state are compared to that of the home's improved state. In this manner, a homeowner can determine the actual, as opposed to estimated, savings resulting from the improvement.

This embodiment is not limited to changes associated with house or building improvements but can be based on other changes such as, for example, changes in appliances (additional, less, replacement, upgrade to high-efficiency, etc.) Furthermore, this embodiment is not limited to comparisons between two data sets for any one home but may include multiple data sets or energy analyses representing multiple improvements or changes to the home over a span of multiple years. In this regard, logic 206 can store and compare multiple energy analyses of a single home. The result of a comparison can be displayed by logic 206 in the same manner as shown in FIG. 10, except data and results prior to the home's efficiency upgrade or other changes will be comparatively displayed as well (either in addition to or in the alternative to the other reference home data and results).

According to another embodiment, a system and method are provided for analyzing real time data (e.g., energy usage and climate) and metering savings. This embodiment can be used to generate comparisons between current and historical energy usage data. For example, if improvements have been made to a building or structure, comparison data can be generated on a daily, weekly, monthly, annual or any other periodic basis. In this manner, energy savings associated with the improved building or structure can be generated in relative real time, essentially metering the savings. Real time data can include periodic or continuous reading of energy usage and climate data. Energy usage data includes, but is not limited to, electric and fossil fuel energy (including current and historical, respectively). Climate data includes, but is not limited to, outdoor temperature, indoor temperature, indoor humidity, outdoor humidity, etc. (both current and historical).

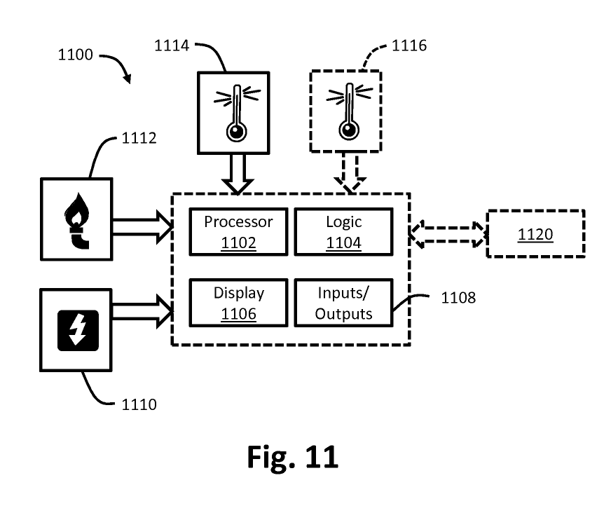

One embodiment of a system for analyzing real time data is illustrated in FIG. 11. System 1100 includes a processor 1102, logic and memory 1104, display 1106 and inputs/outputs 1108. Processor 1102, which can be a microprocessor or other programmable controller, executes logic 1104 and communicates data to and from display 1106 and inputs/outputs 1108. Processor 1102 can also communicate with external devices 1120 to communicate data, both to and from, as needed, via for example, a network. External Devices 1120 can be computer systems including, but not limited to, personal computers, laptop computers, notebook computers, tablet computers, smart phones, etc. External devices 1120 can also be network devices including servers, clients, or other computer systems. Communication with external devices 1120 can be via wired or wireless connection.

System 1100 receives electrical usage data 1110 (e.g., watt-hours), fossil fuel usage data 1112 (e.g., natural gas in cubic feet), and outside climate data 1114, such as outside temperature, as inputs. Additional optional inputs includes indoor climate data 1116, such as inside temperature. Electrical usage data 1110 can be generated by and received from a utility source, such as, for example, an electrical meter or a utility company interface. Fossil fuel data 1112 can be generated by and received from a meter such as, for example, a gas meter, or a utility company interface. Temperature data can be generated by and received from one or more thermometers. Electrical, fossil fuel, and climate data may be read directly through wired or wireless connections. Display 1106 can be used to convey various information such as energy usage, graphs, and other information. Microprocessor 1102, logic and memory 1104, display 1106, and inputs/outputs 1108 may be contained within a housing and located anywhere within, nearby, or associated with a building or structure such as, for example, next to or as part of a climate control unit (e.g., thermostat) for the building or structure.

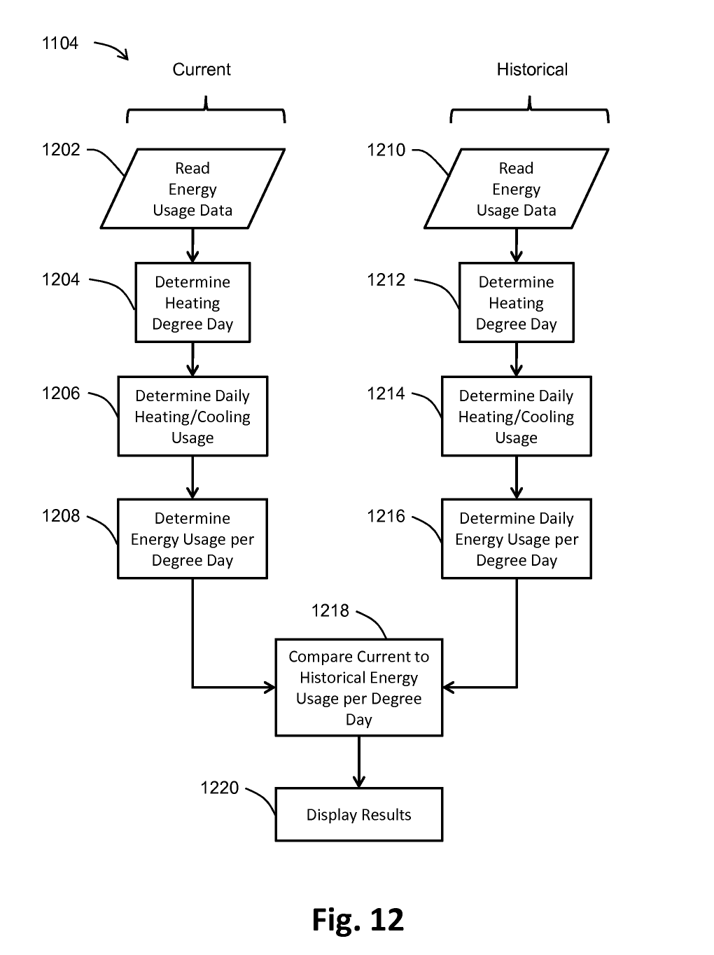

One embodiment of logic 1104 using real time and historical energy usage data is shown in FIG. 12. Logic 1104 compares the current heating and cooling energy usage per degree day with historical heating and cooling energy usage per degree day. The current energy usage per degree day can include a daily, weekly, monthly, quarterly, annual or any other period of analysis. The historical energy usage per degree day can include any previous period of time sufficient to segregate the heating and cooling energy usage from the total energy usage. This is typically one year. For example, the current heating or cooling energy usage per degree day may be performed on a daily basis using the previous day's data. The savings are then determined by subtracting the heating or cooling energy usage for the current period from the historic heating or cooling energy usage per degree day times the degree days for the current period.

Logic 1104 will now be described in the context of comparing energy usage data (current and historical) within the context of daily analyses. Energy usage data is read including electric, fossil fuel, and outside temperature in block 1202. In block 1204, the outside temperature data is used to determine the Heating Degree Day data according to the following:

Heating Degree Data=(65−Daily Temperature)

The variable “HDD65” is the heating degree day (base 65) and the “Daily Temperature” is the temperature for the previous day, which can be an average daily temperature. For example, if the base is 65 F and the Daily Temperature is 32 F for the day, then the Heating Degree Days base 65 is 33 for that particular day. For cooling degree days, the same analysis is done except that CDD base 74 data can be used instead of HDD65. Cooling data is can be expressed as cooling degree hours base 74.

In block 1206, the logic 1104 determines the daily heating/cooling energy usage. For example, typical non-heating and non-cooling electric and natural gas usages are subtracted from the total electric and natural gas usage. The non-heating and non-cooling electric and gas usages can be determined as described above in connection with logic 206. This results in heating and cooling electricity and natural gas usages that are not due to occupant behavior

For example, if the current total electric and natural gas usage for a day is 144 kWh and the historic non-heating and non-cooling energy usage is 42 kWh, then the heating and cooling energy usage for that day is 102 kWh.

In block 1208, the Energy Usage Per Degree Day is determined using the Daily Heating Energy Usage and the Heating Degree Data as follows:

$$Energy Usage per Degree Day = ( \frac{\begin{matrix}Daily Heating \\ Energy Usage\end{matrix}}{Heating Degree Data} )$$

For example, if the Daily Heating Energy Usage is 102 kWh and the Heating Degree Data is 33, then for that particular degree day, the Energy Usage is 3.09 kWh/degree day. Similar calculations can be made for cooling energy usage.

Blocks 1210-1216 perform the same analysis as blocks 1202-1208, but on the relevant historical time period. In the current example, the time period is a daily analysis. Therefore, blocks 1210-1216 perform the same analysis to determine the Energy Usage per Degree Day.

Block 1218 compares the current and historical Energy Usage per Degree Day. For example, if the current Energy Usage per Degree Day is 3.09 kWh/degree day and the historical Energy Usage per Degree Day is 4.12 kWh/degree day, then the current Energy Usage per Degree Day represents an energy savings of about 25% from the historic usage. If the HDD65 for this day is 33, then the savings is determined by subtracting the current energy usage per degree day from the historic energy usage per degree day and multiplying times the current number of degree days. In this example, that would be (4.12-3.09) times 33=34 kWh for that day. The same analysis can be continuously performed on a daily basis and the energy savings or differences can be displayed in block 1220. The results of the comparisons can be displayed in any suitable format including charts, tables, graphics, text or combinations thereof.

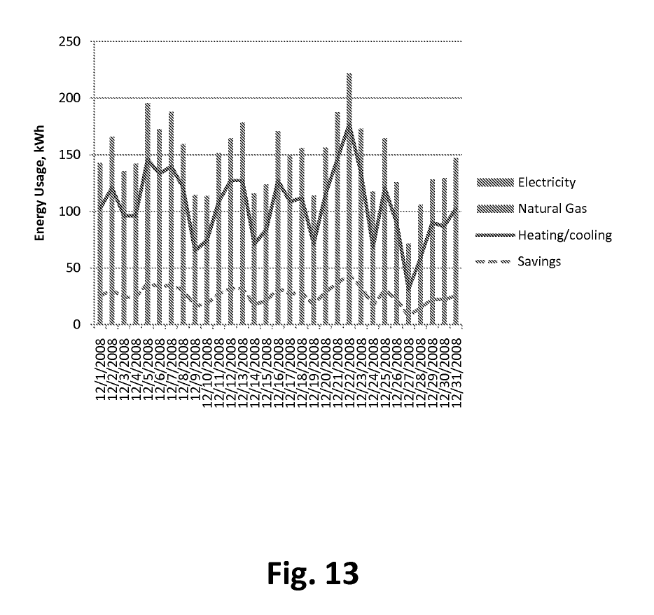

FIG. 13 illustrates one example of a display that can be generated and displayed in block 1220. FIG. 13 shows a combination bar chart and line graph illustrating the daily Electricity and Natural Gas usage, along with the Heating/Cooling energy usage and the energy usage Savings over the historic usage period. As described earlier, the “Savings” data represent savings due to improvements to the building or structure. In this manner, system 1100 uses real time data to generate information representing the energy savings achieved by the improvements.

Any and all data or information sent to or generated by system 1100 can be stored or communicated to external devices 1120 or networks. For example, historical usage data including utility data can be provided from a computer system owned or used by the utility company, management company, or the owner of the building or structure. The current usage data may also be provided by a utility company and may be communicated to external devices such as servers or clients located remotely from the building or structure. Still further logic 1104 may be a component or part of logic 206 of FIG. 2 in other embodiments. Logic 1104 (and logic 206) may reside on remote servers which receive climate and energy usage data from the building or structure and perform the logic described herein.

The system and method of the present invention can be implemented on a variety of platforms including, for example, networked computer systems and stand-alone computer systems. Additionally, the logic and databases shown and described herein preferably reside in or on a computer readable medium such as, for example, a Read-Only Memory (ROM), Random-Access Memory (RAM), programmable read-only memory (PROM), electrically programmable read-only memory (EPROM), electrically erasable programmable read-only memory (EEPROM), magnetic disk or tape, and optically readable mediums including CD-ROM and DVD-ROM. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired.

While the present invention has been illustrated by the description of embodiments thereof, and while the embodiments have been described in considerable detail, it is not the intention of the specification to restrict or in any way limit the scope of the appended claims to such detail. Additional advantages and modifications will readily appear to those skilled in the art. For example, the graphics displays of the present invention can include any type of graphical information or charts. Therefore, the invention, in its broader aspects, is not limited to the specific details, the representative apparatus, and illustrative examples shown and described. Accordingly, departures may be made from such details without departing from the spirit or scope of the applicant's general inventive concept.

1. A computer implemented method for analyzing energy usage of a structure comprising:
reading data associated with the structure, wherein the data associated with the structure comprises utility usage information;
determining an energy usage of the structure by analyzing the data associated with the structure;
conducting a thermal analysis of the structure based on the energy usage of the structure;
generating an energy analysis of the structure; and
displaying the energy analysis of the structure.

2. The method of claim 1, wherein the utility usage information is determined from utility bill records.

3. The method of claim 1, wherein reading data associated with the structure comprises:
reading heating degree days; and
reading cooling degree days.

4. The method of claim 1, wherein determining the energy usage of the structure by analyzing the data associated with the structure comprises determining how energy usage is divided amongst a plurality of usage categories.

5. The method of claim 4, wherein determining how energy usage is divided amongst the plurality of usage categories comprises determining energy usage associated with occupant activity.

6. (canceled)

7. The method of claim 1, wherein determining the energy usage of the structure by analyzing the data associated with the structure comprises determining heating and cooling balance points.

8. The method of claim 1, wherein the data associated with the structure further comprises location of structure, size of structure, foundation type, age of structure, age of HVAC devices; fuel information, insulation information, window information, number of occupants, heating degree days, cooling degree days, and thermostat settings.

9. (canceled)

10. The method of claim 1, further comprising comparing the energy usage of the structure to a comparative energy usage of a comparative structure.

11. The method of claim 10, further comprising:
determining an energy efficiency indicator of the structure; and
comparing the energy efficiency indicator of the structure to a comparative energy efficiency indicator of the comparative structure.

12. The method of claim 1, further comprising:
determining at least one potential energy efficiency improvement for the structure;
estimating a cost to implement at least one potential energy efficiency improvement;
calculating a change in energy usage associated with at least one potential energy efficiency improvement; and
estimating a savings associated with at least one potential energy efficiency improvement.

13. The method of claim 12, further comprising calculating a payback period for at least one potential energy efficiency improvement.

14. The method of claim 12, further comprising:
identifying potential energy efficiency improvements to include in an improvement analysis; and
determining an improved energy usage of the structure based on the identified potential energy efficiency improvements.

15. The method of claim 1, further comprising:
storing a first energy analysis of the structure; and
generating a second energy analysis of the structure;
wherein displaying the energy analysis of the structure comprises displaying the first energy analysis of the structure and the second energy analysis of the structure.

16. (canceled)

17. A computer implemented method for analyzing energy usage of a structure comprising:
executing logic to periodically read data from a utility source associated with the structure, wherein data associated with the structure comprises utility usage information based on the utility source data;
reading outside climate data associated with a location outside of the structure;
determining an energy usage of the structure by analyzing the data associated with the structure and the outside climate data;
generating an energy analysis of the structure; and
displaying the energy analysis of the structure.

18. (canceled)

19. (canceled)

20. The method of claim 17, wherein determining an energy usage of the structure by analyzing the data associated with the structure and the outside climate data comprises:
determining heating degree day data and cooling degree day data based on the outside climate data;
determining heating energy usage and cooling energy usage, which comprises determining energy usage associated with occupant activity; and
calculating heating energy usage per degree day and cooling energy usage per degree day.

21. The method of claim 20, further comprising:
storing a first energy analysis of the structure;
generating a second energy analysis of the structure; and
comparing the first energy analysis to the second energy analysis;
wherein displaying the energy analysis of the structure comprises displaying the comparison of the first energy analysis to the second energy analysis of the structure.

22. (canceled)

23. A system for analyzing energy usage of a structure comprising:
an input device for inputting information to the system;
a display for displaying information to a user of the system;
a memory comprising logic for analyzing energy usage; and
a processor, in communication with the input device, the display, and the memory, for executing logic to:
read data associated with the structure, wherein the data associated with the structure comprises utility usage information;
determine an energy usage of the structure by analyzing the data associated with the structure;
conduct a thermal analysis of the structure based on the energy usage of the structure;
generate an energy analysis of the structure; and
display the energy analysis of the structure.

24. The system of claim 23, wherein the logic comprises a database comprising information for analyzing energy usage.

25. (canceled)

26. The system of claim 23, further comprising a network interface, wherein the network interface interfaces with a network system comprising data, databases, programs, websites, or data processing for analyzing energy usage.

27. (canceled)

28. The system of claim 23, wherein the processor further executes logic to:
periodically read data from a utility source associated with the structure, wherein the data associated with the structure comprises utility usage information based on the utility source data;
read outside climate data associated with a location outside of the structure; and
determine the energy usage of the structure by analyzing the data associated with the structure and the outside climate data.

29-39. (canceled)
